(19) United States
(12) Patent Application Publication
(10) Pub. No.: US 2011/0125513 A1
(43) Pub. Date: May 26, 2011

(54) REAL-TIME METHOD AND SYSTEM FOR CONTROLLING HEALTHCARE DELIVERY PROCESSES WITHIN A CLINICAL ENVIRONMENT

(75) Inventors: Henry J. Tenarvitz, Suttons Bay, MI (US); H.T. Snowday, Traverse City, MI (US); Seth Tabberer, Kingsley, MI (US)

(73) Assignee: VERSUS TECHNOLOGY, INC., Traverse City, MI (US)

(21) Appl. No.: 12/622,959

(22) Filed: Nov. 20, 2009

(51) Int. Cl. G06Q 50/00; G06Q 10/00; H04Q 5/22

(52) U.S. Cl. 705/2; 340/10.1

(57) ABSTRACT

A real-time method and system for controlling healthcare delivery processes within a clinical environment is provided. The clinical environment is monitored by real-time locating apparatus including auto-ID tags. The method includes providing a set of rules which are predefined so as to be representative of a combination of event data and subject data values occurring when the healthcare delivery processes are performing optimally. The method further includes collecting real-time event data which represents the locations of mobile tag-wearing subjects within the environment and events which occur within the facility. The method still further includes collecting subject data which is directly or indirectly related to the tag-wearing subjects and evaluating in real-time the event data and subject data based on the set of predefined rules to measure performance of the processes. The method finally includes performing at least one corrective action to improve the performance of at least one of the processes if a measured performance is less than optimal and unacceptable.

### CROSS-REFERENCE TO RELATED APPLICATION

This application is related to commonly owned U.S. application Ser. No. ______, filed Nov. 20, 2009 (the same day as this application) and entitled “Context-Aware Method And System For Facilitating The Delivery Of Healthcare To Patients Within A Clinical Environment Monitored By Real-Time Locating Apparatus”.

### BACKGROUND OF THE INVENTION

1. Field of the Invention

This invention relates to real-time methods and systems for controlling healthcare delivery processes within a clinical environment. At least one embodiment of the invention relates to methods and systems for monitoring and improving healthcare delivery processes within a clinical environment monitored by a Real-Time Locating System (RTLS). In particular, methods and systems are provided to sense and act upon the “location change events” of mobile, tag-wearing subjects and/or subject pertinent data from other clinical data sources (CDS). The process by which actions occur is dictated by one or more clinical process profiles (rules), each rule having been predefined as to be representative of a combination of event data and subject data values expected when that process is operating optimally.

2. Background Art

Clinical workflows, meaning a chain of events and process steps from a first contact of a patient until his release out of a care program, is a complex cooperation of doctors, clinical staff, diagnostic questions, experimentations done by different departments, modalities, clinical data and conclusions. Prior art clinical workflow steps individually and personally administered by doctors and/or clinical staff use IT systems, rules, and information exchange.

As described in U.S. patent publication 2009/0018882, conventional healthcare delivery systems in hospitals, clinics, and centers are extremely complex environments that are typically managed without a system-wide and detailed understanding of their daily operations and the ever-evolving processes, tools, and technologies supporting these activities. This lack of understanding often creates an overwhelming challenge for all levels of management in their efforts to improve quality, maintain patient and staff safety, and function efficiently in this intricate and highly technical enterprise. Current technology providers design and deliver products with little attention to or knowledge of the actual clinical workflows involved in these daily operations. While some providers purport to automate “workflow”, they generally fail to first define or understand true clinical workflow—the progression and combination of physical, communicative, and cognitive tasks taken to achieve short, medium, and long term clinical and operational outcomes.

Conventional business analytic/intelligence tools, which focus on outcomes measurement, fail to provide the necessary tools for improving the very means (processes, people, policies, environment, etc.) by which these outcomes are achieved. This forces administrators and quality improvement personnel to use manual data collection and analysis methodologies that consume valuable human resources, are wrought with opportunity for error, and often deliver sub-optimal results or entirely missed opportunities. Directors of nursing have openly admitted that they know that nurse behavior changes when the nurse is being watched (Hawthorne effect) and that they have no way of analyzing workflow over time. Many conventional process improvement methodologies (e.g., LEAN and Six Sigma) involve conducting the initiative in the “place of work”, such as a factory.

LEAN tools include the classic just-in-time manufacturing, inventory management, and continuous improvement tools aimed at eliminating the seven classic wastes (transportation, inventory, motion, walking, overproduction, overprocessing, and defects). The LEAN approach emphasizes direct involvement of affect personnel, an iterative approach to eliminating waste (often called Plan-Do-Check-Act or the PDCA cycle), and process simplification. Six Sigma tools include the process control and statistical analysis tools aimed at reducing process and product variation. The Six Sigma approach emphasizes rigorous data analysis and projects structured using the Define-Measure-Analyze-Improve-Control or DMAIC framework.

U.S. patent publication 2009/0018882 discloses a method and system for acquiring a system-wide, knowledge-based, detailed understanding of enterprise workflows, and incorporating various management, training and simulation tools for analyzing and optimizing the workflows to improve inefficiencies and overall operational quality.

The following U.S. patent documents are related to one or more embodiments of the present invention: 2007/0136089; 2008/0082366; 2008/0235057; 2006/0109961; 2008/0235049; 2009/0119124; 2009/0119126; 2009/0138318; and U.S. Pat. No. 7,551,082.

The following U.S. patents are also related to the present invention: U.S. Pat. Nos. 4,868,859; 4,906,853; 5,017,794; 5,027,314; 5,027,383; 5,119,104; 5,131,019; 5,276,496; 5,355,222; 5,387,993; 5,548,637; 5,572,195; 6,104,295; 6,154,139; 6,462,656; and 6,838,992.

One prior art method and system includes a rules engine which monitors the system for the occurrence of specific events and initiates programmed actions based on event conditions. System events include a button press, unauthorized access, extended wait times, etc. and responses such as the alerts are initiated. Event and alert messages can be sent via paper, e-mail, PDA, computer screen pop-up, sound file and HL7.

Rules defined can be simple (e.g., tags reporting at a specific time) to complex, depending on the action required. Many different call and response rules can be written, allowing different levels of notification for many different scenarios. For example, when a particular event occurs (a badged patient enters a restricted area), the rules engine responds with a pre-programmed alert. The alert could consist of one or multiple messages (audible alarms, PC alerts, paper notifications, etc.) to occur simultaneously.

Events can be configured and managed by the customer. The rules engine comes with a set of pre-configured rules in place for a specific application; custom rules can be configured based on current processes.

A number of factors are causing processes or delivery of healthcare to continually grow more complex, more expensive and less safe. These include higher complexity resulting from advancing medical science, the need for increased patient safety and pressures to deliver healthcare more efficiently.

Despite the above-noted prior art, what is needed is a method and system by which multiple processes can be simultaneously monitored for optimal safety and efficiency and mitigating actions can be quickly executed when deviations from the optimum are detected.

### SUMMARY OF THE INVENTION

One or more steps of at least one embodiment of the invention may be implemented alone or in combination in hardware, firmware, and/or as a set of instructions in software. Certain embodiments may be provided as a set of instructions residing on a computer-readable medium, such as a memory, CD, DVD, or hard disk, for execution on a general purpose computer or other processing device, such as, for example, a PC workstation.

An object of the present invention is to provide an improved real-time method and system for controlling healthcare delivery processes within a clinical environment.

Another object of at least one embodiment of the present invention is to provide a method and system to define and monitor common healthcare delivery processes involving mobile, tag-wearing subjects that increase the efficiency of delivery and the safety of each process; is simple and inexpensive to operate and maintain; requires no special training for clinical staff; and that leverages common, pre-existing communication infrastructure, when possible.

Yet another object of at least one embodiment of the present invention is to increase the efficiency and safety of common healthcare delivery processes in a clinical setting by collecting RTLS data as well as other event data captured from a CDS including any systems or databases accessible by the RTLS such as a Clinical Information System, Laboratory System, Radiology System, Admit Discharge Transfer System or a data basing system such as SQL operating concurrently within the clinical setting, evaluating the data elements in any given predefined rule and responding with the corrective actions when process performance degrades below acceptable limits.

In carrying out the above object and other objects of the present invention, a real-time method of controlling healthcare delivery processes within a clinical environment monitored by real-time locating apparatus including auto-ID tags is provided. The method includes providing a set of rules which are predefined so as to be representative of a combination of event data and subject data values occurring when the healthcare delivery processes are performing optimally. The method further includes collecting real-time event data which represents the locations of mobile tag-wearing subjects within the environment and events which occur within the facility. The method still further includes collecting subject data which is directly or indirectly related to the tag-wearing subjects. The method further includes evaluating in real-time the event data and subject data based on the set of predefined rules to measure performance of the processes. The method still further includes performing at least one corrective action to improve the performance of at least one of the processes if a measured performance is less than optimal and unacceptable.

The step of performing may be predefined by the set of rules.

The step of performing may include communicating an audio or video alert to a device.

The alert may be a video alert comprising a text or graphical alert.

The step of performing may include communicating a report to a device.

The step of performing may include communicating a message to a device.

The step of performing may include communicating an activation signal to a device.

Further in carrying out the above object and other objects of the present invention, a real-time system for controlling healthcare delivery processes within a clinical environment monitored by a real-time locating apparatus including auto-ID tags is provided. The system includes a storage device for storing a set of rules which are predefined so as to be representative of a combination of event data and subject data values occurring when the healthcare delivery processes are performing optimally. The system further includes a database of real-time event data which represents the locations of mobile tag-wearing subjects within the environment and events which occur within the facility. The system still further includes a source of subject data which is directly or indirectly related to the tag-wearing subjects. The system further includes a control computer subsystem including a processor operable to execute software instructions, a memory operable to store software instructions accessible by the processor, and a set of software instructions stored in the memory. The set of software instructions at least partially perform the steps of: evaluating in real time the event data and the subject data based on the set of predetermined rules to measure performance of the processes; and performing at least one corrective action to improve the performance of at least one of the processes if a measured performance is less than optimal and unacceptable.

The step of performing may be predefined by the set of rules.

The step of performing may include communicating an audio or video alert to a device.

The alert may be a video alert comprising a text or graphical alert.

The step of performing may include communicating a report to a device.

The step of performing may include communicating a message to a device.

The step of performing may include communicating an activation signal to a device.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic overview diagram illustrating a prior art method and apparatus for locating subjects within a clinical environment; the method and apparatus are also useful in a method and system of at least one embodiment of the present invention;

FIG. 2 is a schematic block diagram specifically illustrating a prior art auto-ID tag useful with the method and apparatus of at least one embodiment of the invention to locate subjects;

FIG. 3 is a diagram similar to the diagram of FIG. 1 but illustrating a pair of different IR receivers in section;

FIG. 4 is a schematic diagram of a system constructed in accordance with at least one embodiment of the present invention and illustrating the integration of various processes on a clinical facility computer/communication network;

FIG. 5 is a view of a possible text alert regarding clinical process performance displayed using at least one embodiment of the present invention;

FIG. 6 is a view of a dashboard-type graphical indicator regarding clinical process performance that can be generated and displayed using at least one embodiment of the present invention; and

FIG. 7 is a time line for a patient and caregivers in a clinical environment illustrating the delivery of healthcare which is controlled by at least one embodiment of a method and system of the present invention.

### DETAILED DESCRIPTION OF THE PREFERRED EMBODIMENT(S)

In general, what is described herein with respect to at least one embodiment of the invention is a method and system wherein rules are defined in terms of conditional results derived from event data and subject data values. The rules are continually evaluated in respect to the most recent event and subject data values to measure the performance of each clinical process corresponding to each rule. Actions are taken in real time to correct the performance of any clinical process performance that is below that indicated in the rules design.

The method includes providing a real-time locating tag which emits infrared (IR) and/or radio frequency (RF) signals representative of each tag's unique ID number that are received by ceiling-mounted sensors whose location is known, for each subject that is involved in the clinical process. Each subject's identification data is associated with each unique tag number. The provision of this tag in a tracking environment allows the RTLS to associate unique tag data with the particular location and the time it was seen at that location.

The method optionally includes the provisions to notify the RTLS that other, non-location change events have occurred including but not limited to:
1. Classifying specific tag IDs into one or more tag types groups such as a “doctor” type, “nurse” type or “patient” type;
2. Implementing one or more “alert” switch(es) to the tag that may be manually or automatically activated to provide the RTLS notification of an event associated to the tag that is non-location based; and
3. Collecting and/or issuing external data event messages pertinent to specific tag IDs or tag type groups represented in a rule such as network messages indicating new patient orders, the results of pending patient orders, patient admission or discharge, etc.

The system of at least one embodiment of the invention includes the aforementioned real-time locating tag in a RTLS environment; a means of storing and/or retrieving the current and historic values of all location and other pertinent CDS data events associated with each subject's unique ID tag; a processor means for continual evaluation of each rule in respect to the current data values stored for each event associated with each tag represented in each rule and performing the actions that may be associated with the specific values that may result from the evaluation of each rule.

Referring now to the drawing figures, the RTLS consists of a number of concurrent processes. These include a tracking process 35 to collect tag 12 information in real time, a messaging process 37 to collect or issue non-tag data messages such as those from a CDS 39 pertinent to each tag 12, an evaluation process 38 to continually evaluate each rule respective to the current values stored or pointed to in the tag database 36 and execute actions, if indicated. Exchange of data from process to process is typically accomplished via a Local Area Network (LAN) 50 that may be connected to the Enterprise Network (Intranet) 51.

The tag database 36 stores tracking process 35, tag 12, specific event data 40 or non-tracking process subject data 41. Event data 40 includes the tag's location and switch state's history. Subject data 41 includes data or pointers to data (information needed to retrieve the data from another source) such as name, medical record number pertinent to each tag's 12 subject.

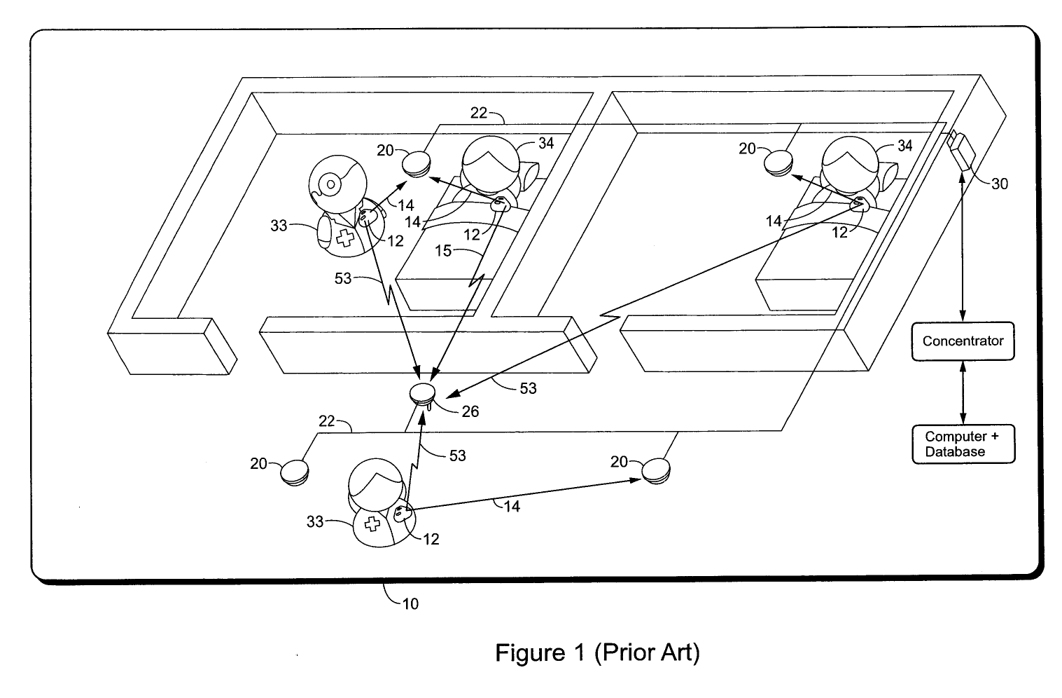

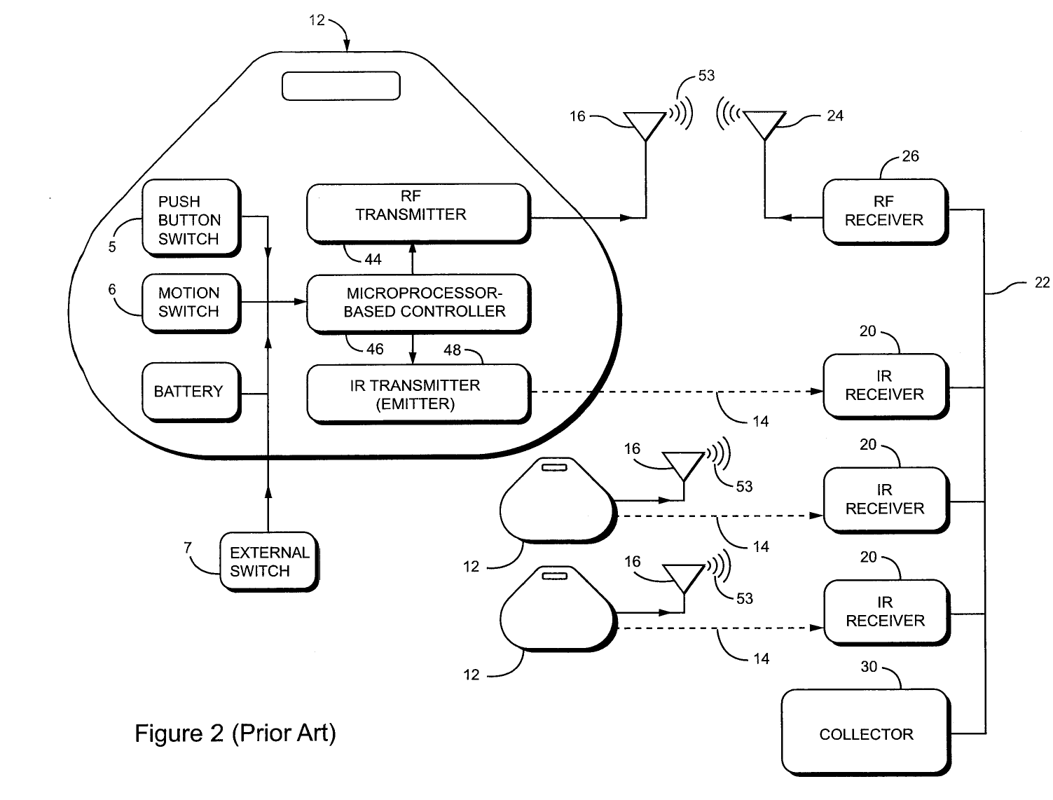

Referring specifically now to FIGS. 1 and 2, there is illustrated a real-time tracking system, generally indicated at 10, which may also be used to capture location change and alert events of each tag-wearing subject. Generally, the system 10 is comprised of tags 12 (worn by subjects or attached to objects) which emit infrared (i.e., IR) signals 14 which are captured by infrared receivers 20 common to the tracking system.

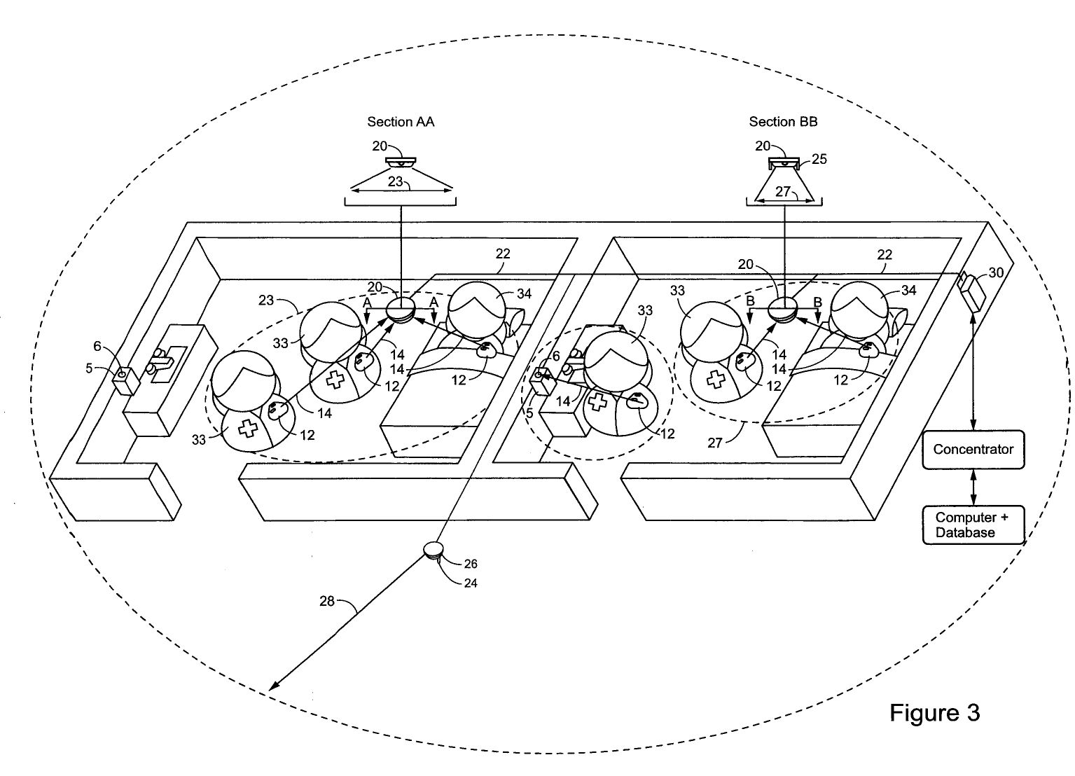

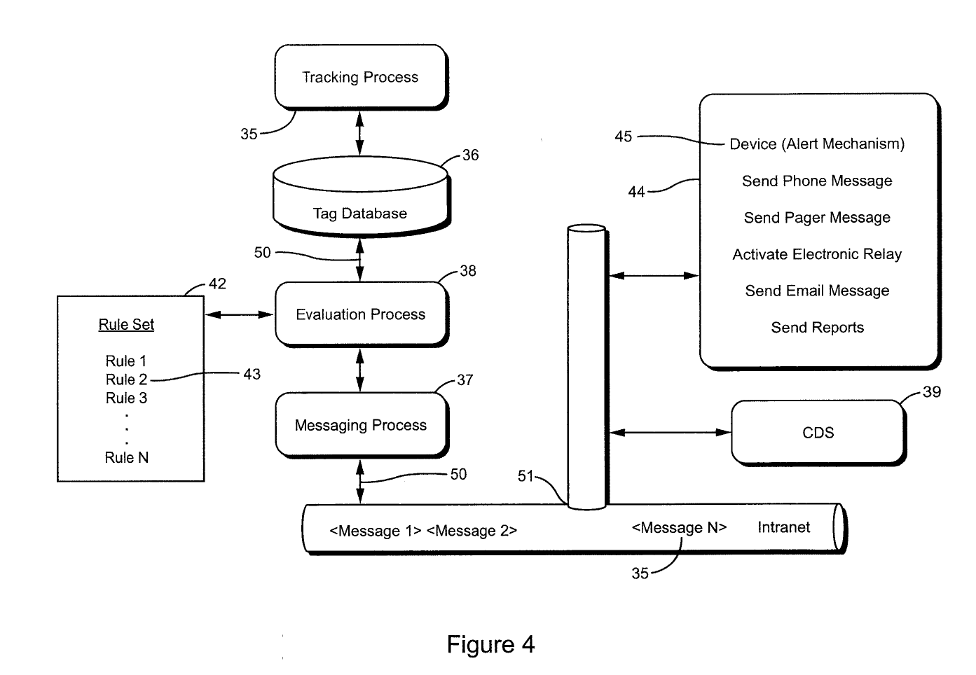

Typically, the maximum effective line-of-sight range of such infrared signals 14 is about a twenty meter diameter 23 (as illustrated by section A-A in FIG. 3). To achieve a more precise location within the system 10, the infrared receiver 20 may have its field of view reduced to as little as a one meter diameter 27 by introducing a restrictor 25 in the IR sensor 20 (as illustrated by section B-B in FIG. 3). The tags 12 may also transmit radio frequency (i.e., RF) signals 53 which are received by an RF receiver 26. The RF signal 53 emitted by the antennas 16 are received by an antenna 24 of a radio frequency receiver 26 having a range of approximately forty meters 28 in all directions. Typically, information is collected using in-ceiling and/or in-wall sensors connected by a serial network 22 that terminates at the microprocessor-based collector 30.

The IR receiver 20 is stationary and its location is known. Tags 12 are worn by mobile subjects and transmit unique IDs 14 which allow the tracking system 10 to associate unique subject identifiers (such as name, medical record number, tag type) to each individual tag 12. With this association, when IR signals 14 are received by an IR receiver 20 the tracking system 10 identifies the tag(s) 12 (and hence the subject or subjects) as being in the location associated with the IR receiver 20. the tracking system 10 aggregates the unique IDs received from the tags 12 enabling the system 10 to identify when one or more unique IDs are present at a particular location (represented by an IR sensor 20).

The tags 12 worn by mobile subjects may also incorporate one or more switches that when activated add an identifier to the data packet transmitted by the tag 12. Typical switch types include manual switches such as an externally accessible push button switch 5 on the tag 12, a motion switch 6 activated automatically by the tags 12 subject's motion or an external switch 7. When activated, a switch may cause the tag 12 to transmit the modified signal immediately or it may transmit the modified signal during the next periodic transmission, depending on the immediacy associated with that switch's function.

The messaging process 37 has two functions. First, it monitors CDS 39 messages 46 typically via direct proprietary interface or standardized interface such as Health Level 7 (HL7), collects data 41 pertinent to each tag's 12 subject then stores that data or points to the data 41 associated to that tag 12 in the tag database 36 for subsequent evaluation by the evaluation process 38. Second, it monitors requests for action 44 from the evaluation process 38 and communicates messages to the device 45 or a CDS 39 pertinent to the evaluation of any given rule 43.

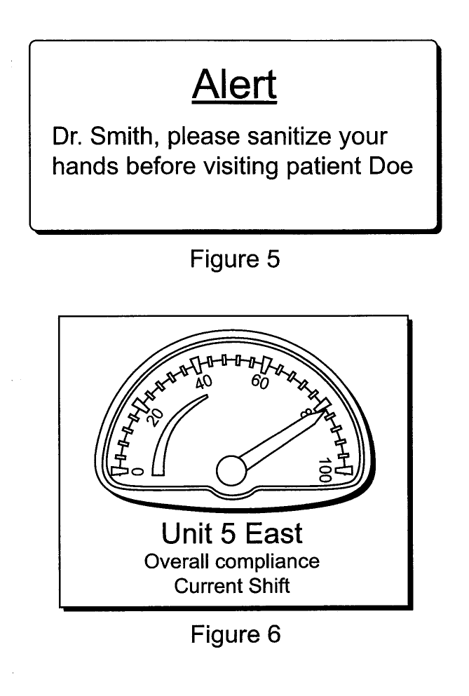

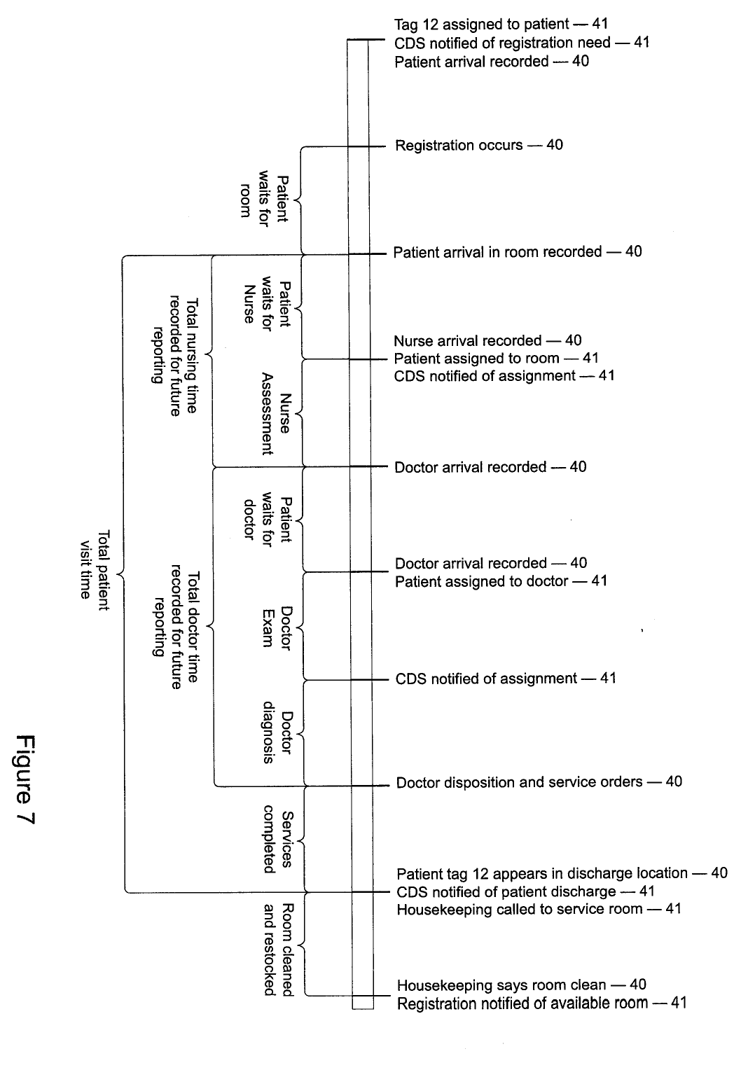

The evaluation process 38 continually evaluates each rule 43 in the rule set 42 using the most recent event data 40 values stored. When the evaluation of a rule 43 indicates the need for an action 44 the evaluation process 38 interprets and executes the specific action 44 indicated by the rule 43 being evaluated. Specific actions 44 typically executed include:
1. Directing the messaging process 37 to communicate a specific message 46 to a device 45;
2. Directing a device 45 to communicate an audio or visual alert to specific locations. An example of this is shown in FIGS. 5 and 6. FIG. 5 illustrates a text message 46 that can be sent to devices 45 such as an alphanumeric pager carried by the caregiver or a computer workstation in the immediate vicinity of the caregiver. FIG. 6 illustrates a message 46 to a dashboard device 45 that can be displayed at the central nurse's station for any given care unit; and
3. Activation of remote relay(s) 44 to manipulate a physical device 45 such as a light or alarm.

Rule sets 42 are comprised of rules 43 that are structured as conditional statements typically taking the “IF THEN ELSE” or “CASE” (“SWITCH”) forms. Examples of rules 43 are:

```
IF (event data 40 and/or subject data 41) TRUE
THEN (take action 44 to send message 46 to device 45)
ELSE (take alternate action 44 or take no action)
CASE (RESULT = evaluated event data 40 and/or subject data 41)
    VALUE 1 (take action 44)
    VALUE 2 (take alternate action 44)
    ...
    VALUE RESULT N (take alternate action 44).
```

Rules 43 are structured in such a way as to compare the progress of a patient, as represented by the current values stored in event data 40 and subject data 41 to value ranges that are known to represent optimized clinical process performance. A very simplified example is shown below:

IF (tag 12 location = “WAITING ROOM” AND tag 12 time in current
location >“15 MINUTES” THEN (action 44 to send message 46 to
WORKSTATION DISPLAY DEVICE 45 (“Check in” tag 12) to
admit clerk).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A real-time method of controlling healthcare delivery processes within a clinical environment monitored by real-time locating apparatus including auto-ID tags, the method comprising:
providing a set of rules which are predefined so as to be representative of a combination of event data and subject data values occurring when the healthcare delivery processes are performing optimally;
collecting real-time event data which represents the locations of mobile tag-wearing subjects within the environment and events which occur within the facility;
collecting subject data which is directly or indirectly related to the tag-wearing subjects;
evaluating in real-time the event data and subject data based on the set of predefined rules to measure performance of the processes; and
performing at least one corrective action to improve the performance of at least one of the processes if a measured performance is less than optimal and unacceptable.

2. The method as claimed in claim 1, wherein the step of performing is predefined by the set of rules.

3. The method as claimed in claim 1, wherein the step of performing includes communicating an audio or video alert to a device.

4. The method as claimed in claim 3, wherein the alert is a video alert comprising a text or graphical alert.

5. The method as claimed in claim 1, wherein the step of performing includes communicating a report to a device.

6. The method as claimed in claim 1, wherein the step of performing includes communicating a message to a device.

7. The method as claimed in claim 1, wherein the step of performing includes communicating an activation signal to a device.

8. A real-time system for controlling healthcare delivery processes within a clinical environment monitored by a real-time locating apparatus including auto-ID tags, the system comprising:
a storage device for storing a set of rules which are predefined so as to be representative of a combination of event data and subject data values occurring when the healthcare delivery processes are performing optimally;
a database of real-time event data which represents the locations of mobile tag-wearing subjects within the environment and events which occur within the facility;
a source of subject data which is directly or indirectly related to the tag-wearing subjects; and
a control computer subsystem including a processor operable to execute software instructions, a memory operable to store software instructions accessible by the processor, and a set of software instructions stored in the memory to at least partially perform the steps of:
evaluating in real time the event data and the subject data based on the set of predetermined rules to measure performance of the processes; and
performing at least one corrective action to improve the performance of at least one of the processes if a measured performance is less than optimal and unacceptable.

9. The system as claimed in claim 8, wherein the step of performing is predefined by the set of rules.

10. The system as claimed in claim 8, wherein the step of performing includes communicating an audio or video alert to a device.

11. The system as claimed in claim 10, wherein the alert is a video alert comprising a text or graphical alert.

12. The system as claimed in claim 8, wherein the step of performing includes communicating a report to a device.

13. The system as claimed in claim 8, wherein the step of performing includes communicating a message to a device.

14. The system as claimed in claim 8, wherein the step of performing includes communicating an activation signal to a device.
